(19) United States
(12) Patent Application Publication
(10) Pub. No.: US 2025/0277738 A1
(43) Pub. Date: Sep. 4, 2025

(54) OPTICAL REFERENCE STANDARD

(71) Applicant: CLAAS Selbstfahrende Erntemaschinen GmbH, Harsewinkel (DE)

(72) Inventors: Robert Schulenburg, Dortmund (DE); Ralf Marbach, Versmold (DE)

(73) Assignee: CLAAS Selbstfahrende Erntemaschinen GmbH, Harsewinkel (DE)

(21) Appl. No.: 19/069,503

(22) Filed: Mar. 4, 2025

(30) Foreign Application Priority Data
Mar. 4, 2024 (DE) 10 2024 106 178.2

(51) Int. Cl. G01N 21/27; A01D 43/08; B32B 27/08; B32B 27/32; B32B 37/06; B32B 37/10; B32B 37/18

(52) U.S. Cl. CPC G01N 21/278; A01D 43/085; B32B 27/08; B32B 27/322; B32B 37/06; B32B 37/10; B32B 37/182; B32B 2250/242; B32B 2307/7376; B32B 2327/18; B32B 2410/00

(57) ABSTRACT

An optical reference standard. The optical reference standard comprises a first layer containing PTFE and a second layer containing a PTFE derivative. The second layer at least partially covers the first layer.

### CROSS REFERENCE TO RELATED APPLICATION

This application claims priority under 35 U.S.C. § 119 to German Patent Application No. DE 10 2024 106 178.2 filed Mar. 4, 2024, the entire disclosure of which is hereby incorporated by reference herein.

### TECHNICAL FIELD

The present invention relates to an optical reference standard, a method for producing an optical reference standard, and the use of an optical reference standard.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2008/024760 A1, incorporated by reference herein in its entirety, discloses a self-propelled harvester designed as a forage harvester with a measuring device for detecting a constituent of a material examined with the measuring device. The measuring device uses near-infrared (NIR) spectroscopy to detect the constituent. In so doing, the material to be examined is irradiated and reflected by the measuring light. The reflected radiation contains information about the sample absorption and therefore also about the concentration of the ingredients of the material.

Such measuring devices also require a so-called spectroscopic reference measurement to determine the optical properties of the measuring device so that the optical properties of the measuring device may be taken into account when analyzing the radiation reflected by the sample.

US Patent Application Publication No. 2008/024760 A1 therefore describes that, in addition to the sample, an optical reference standard designed as a white standard is irradiated in order to determine the reflection behavior of the measuring device. Alternatively, the optical reference standard may be irradiated instead of the material to be examined. In so doing, a white standard must meet high optical requirements. On the one hand, the reflection behavior of the reference standard should have a particularly high long-term stability. Also, the reflectivity of the reference standard should not substantially depend on the wavelength. With regard to a so-called white standard, it should also have particularly high reflectance values of at least approximately 100%. Due to its optical properties, sintered Polytetrafluoroethylene (PTFE) has proven to be particularly suitable for use as a white standard. PTFE is a synthetic fluoropolymer of tetrafluoroethylene, with the commonly known brand name of PTFE-based composition being Teflon.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 schematically illustrates an optical reference standard.

FIG. 2 schematically illustrates a first variant of a manufacturing process of a reference standard according to FIG. 1.

FIGS. 3A-B schematically illustrates a second variant of a manufacturing process of a reference standard according to FIG. 1.

FIGS. 4A-B schematically illustrate a third variant of a manufacturing process of a reference standard according to FIG. 1.

FIG. 5 schematically illustrates a side view of a forage harvester with a measuring device.

### DETAILED DESCRIPTION

As discussed in the background, sintered PTFE has proven particularly suitable for use as a white standard. However, PTFE standards have the disadvantage of having a high risk of contamination. Although PTFE standards are extremely hydrophobic, they absorb non-polar substances such as greases and oils in their microscopically small air holes. This may be particularly disadvantageous when using PTFE standards in agricultural technology, such as in self-propelled harvesting machines, since the harvesting process creates a particularly dusty and polluting environment.

Thus, in one or some embodiments, an optical reference standard is disclosed that may meet the optical requirements and may have a surface resistant to soiling.

This may be achieved using an optical reference standard comprising at least a first layer containing PTFE, and at least a second layer that contains a PTFE derivative that at least partially covers the first layer.

Such an optical reference standard may have one or more advantages. PTFE has particularly advantageous optical properties for use as an optical reference standard, such as for calibrating optical measuring devices. Coating PTFE with a PTFE derivative additionally may enable the first layer to be protected from external influences. This may create an optical reference standard with a PTFE layer that has an improved surface. The PTFE derivative may make the surface less permeable to certain substances (e.g., oil and grease), such as impermeable to oil and grease, and may make the surface wipeable. The surface of the reference standard may also be more easily inspected visually for damage.

In one or some embodiments, the first layer comprises (or consists of) PTFE, such as polytetrafluoroethylene. The PTFE derivative may be formed as a Fluorinated Ethylene Propylene (FEP), such as a tetrafluoroethylene-hexafluoropropylene copolymer, with the second layer comprising (or consisting of) FEP. FEP may comprise (or consist of) a copolymer of hexafluoropropylene and tetrafluoroethylene. It may differ from PTFE resins in that FEP may be melt-processable using conventional injection molding and screw extrusion techniques. FEP may be very similar in composition to PTFE. FEP may share PTFE's useful properties of low friction and non-reactivity, but may be more easily formable. Specifically, FEP may be softer than PTFE and may melt at 260° C. Further, FEP may be highly transparent and resistant to sunlight.

Since the first layer comprises (or consists of) 100% PTFE by weight and the second layer comprises (or consists of) 100% FEP by weight, the reference standard may achieve excellent optical properties. Furthermore, the melting point of FEP may be below the melting point of PTFE so that the materials may be welded together particularly well.

In one or some embodiments, the PTFE is designed as sintered PTFE. A high number of microscopically small air holes may cause the sintered PTFE to diffusely reflect incident light, wherein the reflectivity over a broad spectral range, such as in the near-infrared range, may be almost 100% (e.g., more than 95%, more than 96%, more than 98%, more than 98%, or more than 99%). Sintered PTFE may therefore be particularly suitable as an optical reference standard. In an alternative embodiment, however, the PTFE may also be formed as expanded Teflon, which is also known as expanded PTFE (ePTFE). In one or some embodiments, ePTFE may comprise a stretched out form of PTFE.

In order to prevent light from shining through the first layer, the first layer may have a thickness of at least 2 mm, such as a layer thickness in the range of 4 mm to 6 mm.

Furthermore, in one or some embodiments, the second layer may have a layer thickness in the range of at least 10 pm to a maximum of 100 pm, such as a layer thickness in the range from 40 pm to 60 pm. If the second layer has a layer thickness of at least 10 pm, the second layer may effectively protect the first layer against mechanical influences. However, exceeding a layer thickness of 100 pm may negatively affect the transparency of the second layer and may therefore negatively affect the optical properties of the reference standard since the second layer may only serve as a protective layer. Consequently, in one or some embodiments, the second layer does not exceed a maximum layer thickness of 100 pm.

In one or some embodiments, a method is disclosed for producing an optical reference standard that comprises at least a first layer which contains (or consists of) PTFE, wherein a second layer that contains (or consists of) a PTFE derivative is applied to the first layer.

In one or some embodiments, in a first step, the first and second layers are stacked on top of each other and subjected to pressure in order to avoid the formation of bubbles during the joining process of the two layers. In one or some embodiments, in a second step, the first layer is heated using or via a heating element, such as directly heating the first layer (but the second layer is not heated directly). This may heat the two layers, whereby the layers are bonded or welded to each other. The contact pressure may also cause the second layer, such as the FEP, to adhere in the pores of the first layer.

In an alternative embodiment, the first or the second layer may be heated in a first step, wherein the first or the second layer may be heated using an oven or the like, and wherein in the second step the first and second layers are stacked on each other and subjected to pressure.

In one or some embodiments, the first or second layer is heated to a temperature that corresponds at least to the melting temperature of the PTFE derivative and is lower than the melting temperature of PTFE. This may cause the PTFE derivative to reach a viscous state, wherein the PTFE derivative is deposited in the pores of the first layer. The pressurization may also cause the PTFE derivative to settle in the pores of the PTFE.

In one or some embodiments, the pressurized layers may be cooled in a third step. During the cooling of the second layer, its density may increase and may physically adhere to the pores of the first layer.

In one or some embodiments, the use of an optical reference standard in a measuring device of a self-propelled harvesting machine is disclosed. An optical reference standard designed in this way may be particularly advantageously suited for use in a measuring device of a self-propelled harvesting machine, especially since the optical reference standard has a particularly robust and dirt-resistant surface and is therefore particularly durable and reliable to use despite the adverse environmental conditions during a harvesting process.

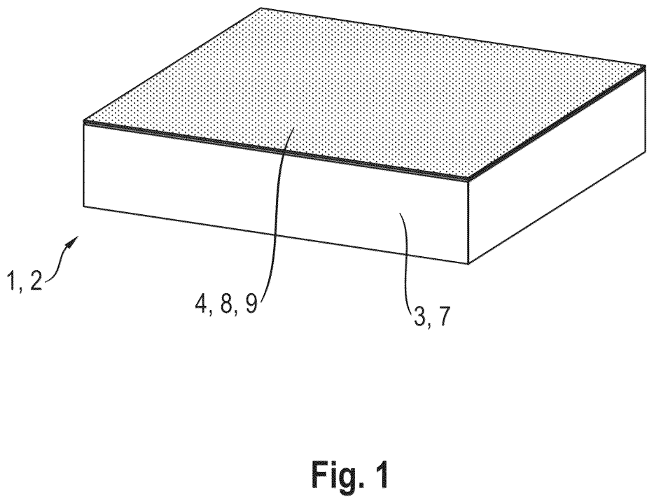

Referring to the figures, FIG. 1 illustrates an optical reference standard 2 designed as a white standard 1. The optical reference standard comprises (or consists of) a first layer 3 and a second layer 4. In one or some embodiments, a main surface of the first layer 3 may be at least partly (or entirely) covered by the second layer 4. The first layer 3 may comprise (or consists of) PTFE 7, which may be a particularly preferred material for use as a white standard 1 due to its optical properties. PTFE 7, which is the abbreviation for polytetrafluoroethylene, may have a particularly high long-term stability of its reflective properties. Furthermore, the reflectivity of PTFE 7 may be substantially independent of the wavelength of the reflected light. PTFE 7 may also have particularly high reflection values of almost 100%, which may be why this material is particularly suitable as a white standard 1. In one or some embodiments, the first layer 3 comprises (or consists of) sintered PTFE 7. Sintered PTFE 7 may have a high number of microscopically small holes and may achieve a reflectivity of over 98% over broad spectral ranges, such as in the near-infrared range.

The second layer 4 may comprise (or consist of) FEP 8, which may be a PTFE derivative 9. FEP 8 is the abbreviation for tetrafluoroethylene-hexafluoropropylene copolymer. The second layer 4 may serve as a protective layer for the surface of the first layer 3. FEP 8 has proven to be particularly advantageous for this purpose. On the one hand, a thin layer of FEP 8 may hardly deflect incident light, such as in the near-infrared range, and basically does not absorb it. Therefore, the optical properties of the first layer 3 may remain substantially unchanged despite the coating with the second layer 4. In addition, FEP 8 may be impermeable to oil and grease and may be mechanically more robust than PTFE 7.

The first layer 3 may have a layer thickness of at least 2 mm. This may prevent light from shining through the first layer 3. A layer thickness of the first layer 3 in the range of 4 mm to 6 mm, such as a layer thickness of 5 mm, may be particularly advantageous.

The second layer 4 may have a layer thickness of at least 10 pm to a maximum of 100 pm, such as a layer thickness in the range of 40 pm to 60 pm, or more particularly a layer thickness of 50 pm. From a layer thickness of 10 pm, it has been shown that the second layer 4 may effectively protect the first layer 3 against mechanical loads. At a layer thickness of more than 100 pm, the transparency of the second layer 4 may decrease so that the optical properties of the white standard 1 are negatively affected since FEP 8 is merely a protective layer, and the optical properties of PTFE 7 are utilized in the use as a white standard 1.

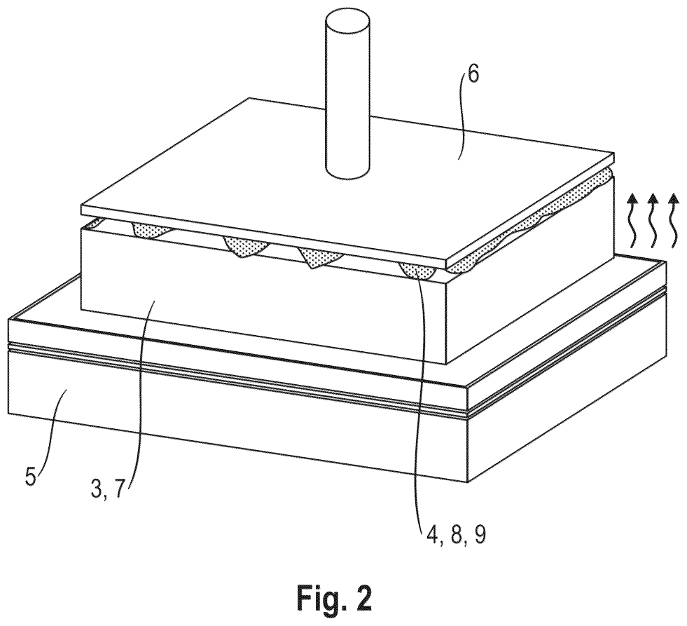

In one or some embodiments, the second layer 4 may be welded or bonded to the first layer 3. This joining method may be applicable because the melting point of FEP 8 lies below the melting point of PTFE 7. Various methods of welding or bonding are contemplated. Three variants, by way of example, may be used for joining the first layer 3 and the second layer 4, which are explained in more detail below with reference to FIGS. 2-4.

According to the first variant illustrated in FIG. 2, the first layer 3 and the second layer 4 are first stacked on top of each other and subjected to pressure in the first step so that the second layer 4 is pressed against the first layer 3. In one or some embodiments, the first layer 3 and the second layer 4 are loaded with a weight 6 for pressurization, wherein the weight 6 has a polar surface. Polar surfaces may have a repellent effect on PTFE 7 and the PTFE derivative 9 so that the weight 6 may be easily removed. The weight 6 may, for example, have a surface of steel, iron, aluminum or ceramic. In a second step, the first layer 3 may be heated directly using a heating element 5. The heating element 5 may be a heating plate, for example. Heat energy may be transferred from the first layer 3 to the second layer 4. This may heat up the Teflon derivative 9 and may solidify it under the contact pressure. In a third step, the layers 3 and 4, which may be subjected to pressure by the weight 6, are cooled. The method steps may be performed in chronological order.

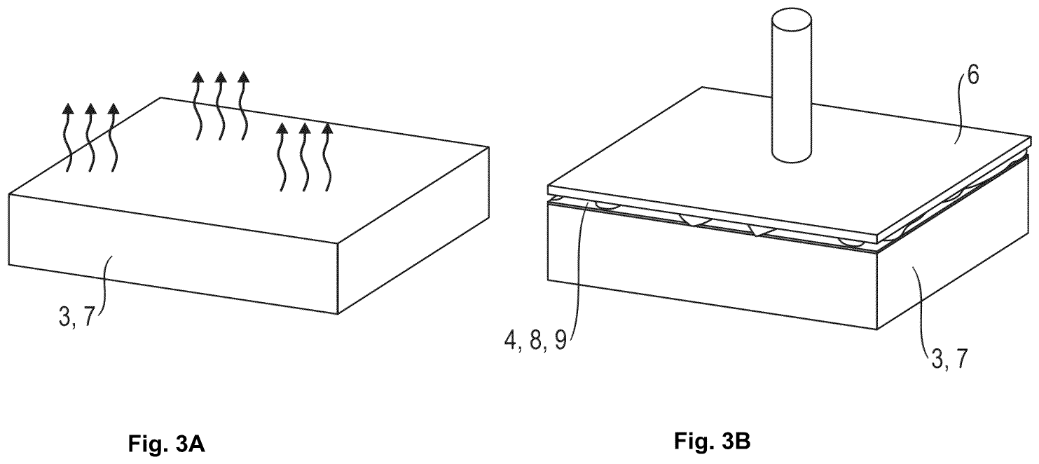

FIGS. 3A-B illustrate a second variant for joining the first layer 3 and the second layer 4. According to the variant illustrated in FIG. 3A, the first layer 3 is first heated in an oven not shown here. In a second step (illustrated in FIG. 3B), the second layer 4 is layered onto the heated first layer 3 and loaded by means of a weight 6 in the same way as the first variant described above and shown in FIG. 2. This may heat up the Teflon derivative 9 and may solidify it under the contact pressure. In a third step, the layers 3 and 4, which are pressurized by the weight 6, may be cooled. The method steps may be performed in chronological order.

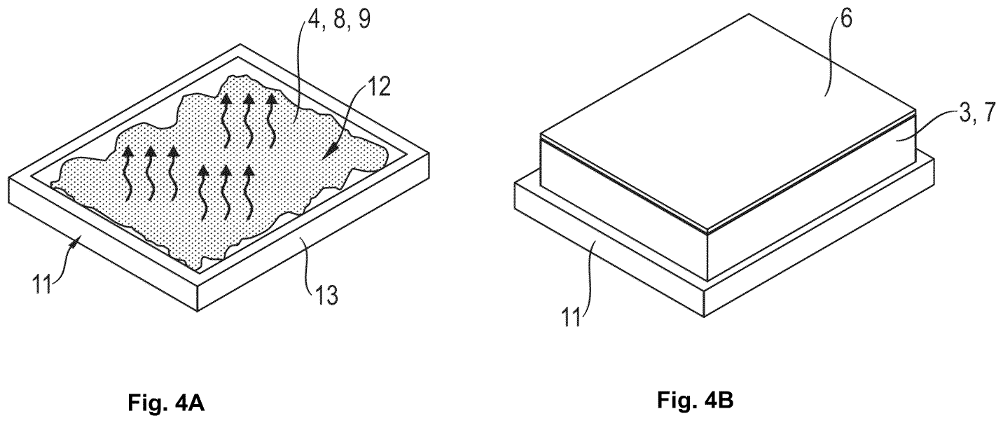

FIGS. 4A-B shows a third variant for joining the first layer 3 and the second layer 4. In contrast to the second variant, in this third variant, the second layer 4 is heated in an oven. See FIG. 4A. For this purpose, the second layer 4 may be placed in a mold 11 before heating, which may have a flat base surface 12 with laterally delimiting edges 13. In the second step (illustrated in FIG. 4B), the first layer 3 is layered onto the heated second layer 4 and subjected to pressure by a weight 6 previously described in more detail above. In a third step, the heated Teflon derivative 9 may release thermal energy to the first layer 3 and may be solidified under the contact pressure. The method steps may be performed in chronological order.

In all three variants described above, the first layer 3 and/or second layer 4 may be heated to a temperature that corresponds at least to the melting temperature of the PTFE derivative 9 and may be lower than the melting temperature of PTFE 7. In all three variants, the second layer 4 or the PTFE derivative 9 may reach a more elastic state or a viscous state when heated. The pressurization may also ensure that the PTFE derivative 9 settles in the pores of the PTFE 7.

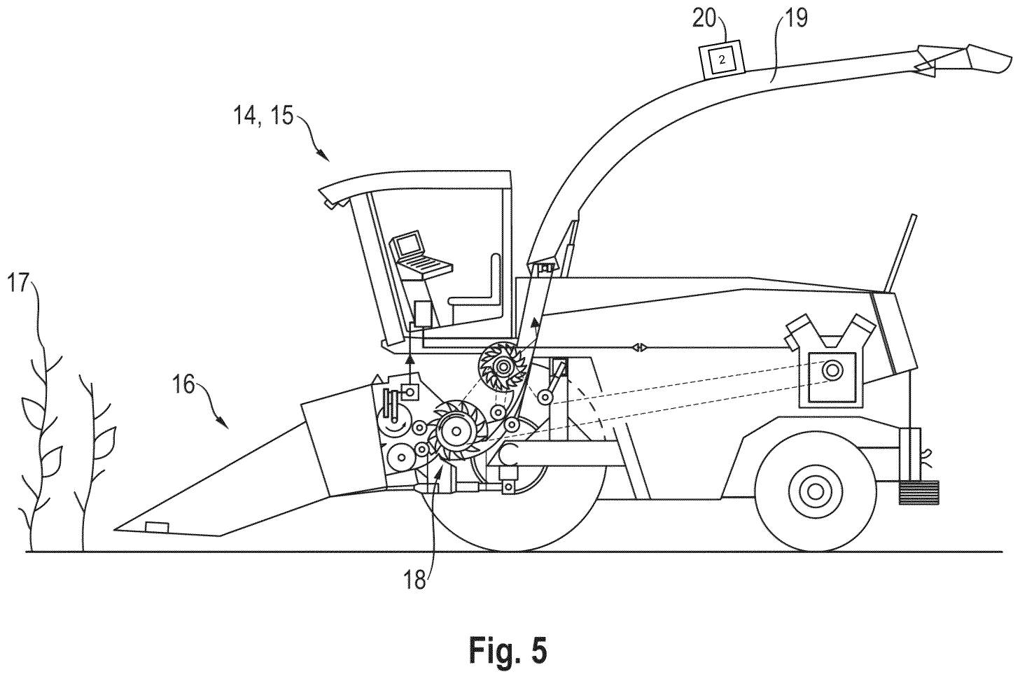

FIG. 5 illustrates a side view with a partially sectional view of a self-propelled harvester 15 designed as a self-propelled forage harvester 14. Example forage harvesters are disclosed in US Patent Application Publication No. 2022/0071091 A1, US Patent Application Publication No. 2023/0060670 A1, US Patent Application Publication No. 2023/0232740 A1, and US Patent Application Publication No. 2024/0196796 A1, each of which is incorporated by reference herein in their entirety. The forage harvester 14 may have a front attachment 16 for picking up or collecting harvested material 17, a chopping unit 18 which comminutes the picked-up harvested material 17, and a discharge chute 19 for transferring the comminuted harvested material 17 to a transport vehicle. The basic structure of a forage harvester 14 is sufficiently known from the prior art and is not described in more detail here. A measuring device 20 configured to analyze the harvested material 17 conveyed through the discharge chute 19 may be located or positioned on or relative to the discharge chute 19. The measuring device 20, known per se, may serve to determine certain constituents of the harvested material 17. With regard to the more detailed determination of the constituents and the structure of the measuring device 20, reference is made to US Patent Application Publication No. 2008/024760 A1, incorporated by reference herein in its entirety. A white standard 1 may be used to calibrate the measuring device 20. In one or some embodiments, the employed white standard 1 may be formed by (such as only formed by) the first layer 3 and the second layer 4 according to the above description. Such a white standard 1 may be particularly advantageous for use in a measuring device 20 of a self-propelled harvester 15, especially since it has a particularly robust and dirt-resistant surface.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 White standard
2 Reference standard
3 First layer
4 Second layer
5 Heating element
6 Weight
7 PTFE
8 FEP
9 PTFE derivative
10 Heating element
11 Mold
12 Base surface
13 Edge
14 Forage harvester
15 Harvesting machine
16 Attachment
17 Harvested material
18 Chopping unit
19 Discharge chute
20 Measuring device

1. An optical reference standard comprising:
a first layer that contains Polytetrafluoroethylene (PTFE); and
a second layer that contains a PTFE derivative and at least partially covers a surface of the first layer.

2. The optical reference standard of claim 1, wherein the first layer consists of PTFE; and
wherein the PTFE derivative is formed as Fluorinated Ethylene Propylene (FEP).

3. The optical reference standard of claim 2, wherein the FEP comprises tetrafluoroethylene-hexafluoropropylene copolymer.

4. The optical reference standard of claim 2, wherein the second layer consists of the FEP.

5. The optical reference standard of claim 1, wherein the PTFE comprises sintered PTFE.

6. The optical reference standard of claim 1, wherein the first layer has a layer thickness of at least 2 mm.

7. The optical reference standard of claim 6, wherein the first layer has the layer thickness in a range from 4 mm to 6 mm.

8. The optical reference standard of claim 6, wherein the second layer has a layer thickness in a range from at least 10 pm to a maximum of 100 pm.

9. The optical reference standard of claim 6, wherein the second layer has a layer thickness in a range from 40 pm to 60 pm.

10. A method for manufacturing an optical reference standard, the method comprising:
placing a first layer that contains Polytetrafluoroethylene (PTFE); and
applying a second layer that contains a PTFE derivative to the first layer.

11. The method of claim 10, wherein the first layer consists of PTFE; and
wherein the PTFE derivative is formed as Fluorinated Ethylene Propylene (FEP).

12. The method of claim 11, wherein the FEP comprises tetrafluoroethylene-hexafluoropropylene copolymer.

13. The method of claim 10, wherein, in a first step, the first layer and the second layer are stacked on top of one another and subjected to pressure; and
wherein, in a second step, a heating element heats the first layer.

14. The method of claim 13, wherein the first layer is heated to a temperature corresponds at least to a melting temperature of the PTFE derivative and is lower than a melting temperature of PTFE.

15. The method of claim 14, wherein the heating element heats the first layer directly but does not heat the second layer directly.

16. The method of claim 15, wherein in a third step performed after the second step, the first layer and the second layer are cooled.

17. The method of claim 10, wherein, in a first step, the first layer or the second layer are heated; and
wherein, in a second step performed after the first step, the first layer and the second layer are stacked on top of each other and subjected to pressure.

18. The method of claim 17, wherein the first layer or the second layer is heated to a temperature corresponds at least to a melting temperature of the PTFE derivative and is lower than a melting temperature of PTFE.

19. The method of claim 18, wherein in a third step performed after the second step, the first layer and the second layer are cooled.

20. A self-propelled harvesting machine comprising:
at least one chopping unit configured to comminute harvested material that is collected;
at least one discharge chute configured to transfer the harvested material that is comminuted; and
a measuring device positioned to analyze at least a part of the harvested material transferred via the at least one discharge chute, the measuring device including an optical reference standard that comprises:
a first layer that contains Polytetrafluoroethylene (PTFE); and
a second layer that contains a PTFE derivative and at least partially covers a surface of the first layer.
